(19) United States
(12) Patent Application Publication
(10) Pub. No.: US 2025/0005461 A1
(43) Pub. Date: Jan. 2, 2025

(54) GROUP TRAVEL RESOURCE CONTRACTING SYSTEM, METHODS, AND APPARATUS

(71) Applicant: Grup(Ease), LLC, San Diego, CA (US)

(72) Inventors: Matthew MARTINEZ, San Diego, CA (US); Theodore MOSETICK, San Diego, CA (US)

(21) Appl. No.: 18/709,642

(22) PCT Filed: Nov. 11, 2022
(86) PCT No.: PCT/US2022/079683

§ 371 Date: May 13, 2024

Related U.S. Application Data
(60) Provisional application No. 63/278,198, filed on Nov. 11, 2021.

(51) Int. Cl. G06Q 10/02; G06F 40/205; G06Q 10/087; G06Q 50/14

(52) U.S. Cl. CPC G06Q 10/02; G06F 40/205; G06Q 10/087; G06Q 50/14

(57) ABSTRACT

The present disclosure provides a new and innovative system, methods, and apparatuses for group travel resource contracting. The system, methods, and apparatuses provide an online framework that enables tour operators to quickly determine which travel resources have availably based on their specified criteria, including criteria that relates to a number of people in a tour group. The system, methods, and apparatuses also provide for the automatic generation of a contract based on specified contract term parameters, selected dates, and corresponding pricing for a selected travel resource. Together, the case of viewing travel resource availability and the automatic contract generation reduces the manual time spent by group travel agencies from days or weeks to only a few minutes to reserve group travel.

### BACKGROUND

Tour operators and other group travel agencies are often neglected by online reservation systems. Despite generating billions of dollars a year worldwide for lodging, motor coaches, excursions, and guides, online reservation systems are only designed to handle individual user reservations, especially for hotels and other types of lodging. This leaves tour operators with the manual and time intensive task of contracting with providers of travel resources. For some tour operators, this can include sending hundreds of separate emails to various group travel resources to obtain inventory levels, pricing, and contract terms.

FIG. 1 shows a known travel resource planning document 10 of a tour operator. The document 10 includes a tour code, a city, an arrival date, a departure date, and a number of rooms needed. Presently, the tour operator has to call or send emails to different lodging providers (and other travel resource providers) in the listed city to determine if there is availability at their property for the specified number of rooms for the specified stay duration. If there is availability, the tour operator receives from the lodging provider a price for each of the specified days. The tour operator may also have to inquire about important contract terms, such as cancellation periods, attrition percentage, comp policy, billing, bed types, parking, and porterage. Further, the tour operator has to take into consideration certain property amenities, such as whether the property has a pool, workout room, distance to certain attractions, meal options, etc. In addition to all of these considerations, the tour operator then has to compare prices, contract terms, and amenities for the available properties to select a desired property for the group tour. In all, this process can take days to weeks depending on the responsiveness of lodging providers and the number of cities/dates for which lodging needs to be reserved.

Even after a property is selected, the tour operator has to request a contract from the lodging provider. As one can appreciate, each lodging provider has their own contract with its own terms and conditions. The tour operator has to ensure the desired contract terms and agreed price are reflected in the contract before signing. The tour operator then has to ensure the lodging provider signs and returns the contract. This signing process can add additional days or weeks to this extremely manual process.

A need accordingly exists for a system that automatically generates a contract to reserve one or more resources for group travel.

### SUMMARY

A group travel resource contracting system, methods, and apparatuses are disclosed herein. The example system, methods, and apparatuses are configured to automatically create contracts to reserve travel resources using predefined contract term parameters in addition to dates selected by a travel/tour operator and corresponding prices specified by a travel resource provider. The example system, methods, and apparatuses are configured to electronically receive, for example, the travel resource planning document 10 of FIG. 1 and automatically parse the document by specified cities and corresponding specified dates. The travel criteria specified by the document is used by the system, methods, and apparatuses as search inputs or queries to automatically perform inventory or availability queries with servers of travel resource providers.

Results from the inventory or availability queries are used by the system, methods, and apparatuses to create a user interface that provides useful information about each travel resource for the travel/tour operator. The useful information includes a graphic that shows the specified dates, whether there is availability for the travel resource for each of the specified dates, and a resource unit price for each of the specified dates with availability. In the context of lodging, the availability information lets a tour operator know for which of the specified dates a particular hotel property or other lodging has enough rooms to meet the needs of the tour. Further, the per/room pricing for each date or range of dates shows potential pricing variability over all of the specified dates. The system, methods, and apparatuses are configured to calculate an average room rate for dates selected by a user for added convenience.

As disclosed herein, travel resource providers are configured to provide a contract template for the system, methods, and apparatuses disclosed herein. The contract template specifies contract term parameters, such as a cancellation period, an attrition percentage, a comp policy, a billing policy, a bed type, a parking policy, and/or a porterage policy. These contract term parameters are used by the system, methods, and apparatuses for filtering which travel resources are presented when a tour operator uses at least some of the contract terms as filter criteria. For instance, a tour operator may only be interested in hotels that have a direct billing policy as well as comped parking for motor coaches. Upon filtering of those contract term parameters, the example system, methods, and apparatuses are configured to display only those hotels or other lodging properties that have agreed to offer the desired contract term parameters in their contract template.

After selection of a travel recourse and one or more dates, the system, methods, and apparatuses disclosed herein enable a tour operator to quickly create a contract from the contract template. The system, methods, and apparatuses use the one or more selected dates and corresponding room prices in conjunction with pre-specified contract term parameters to generate an electronic contract file, which may be signed electronically by the tour operator and the travel resource provider. The system, methods, and apparatuses are configured to manage the signing of the electronic contract file, including storing the signed contract file and indicating when a contract for a travel resource is fully executed and reserved. The example system, methods, and apparatuses reduce the time for contract creation and execution from days or weeks to mere minutes or hours.

The system, methods, and apparatuses disclosed herein accordingly provide an online framework that enables tour operators to quickly determine which travel resources have availably based on their specified criteria, including criteria that relates to a number of people in a tour group that cannot be specified using known online travel services. The system, methods, and apparatuses also provide for the automatic generation of a contract based on already specified contract term parameters, selected dates, and corresponding pricing for a selected travel resource. Together, the ease of viewing available travel resources and the automatic contract generation reduces the manual time spent by group travel agencies from days or weeks to only a few minutes in many instances. The system, methods, and apparatuses are configured such that modification or changes to current online reservation systems are not needed.

In an aspect of the present disclosure, any of the structure, functionality, and alternatives disclosed in connection with any one or more of FIGS. 1 to 17 may be combined with any other structure, functionality, and alternatives disclosed in connection with any other one or more of FIGS. 1 to 17.

In light of the present disclosure and the above aspects, it is therefore an advantage of the present disclosure to provide a group travel contracting system that automatically searches for and aggregates in one user interface group travel resources of different providers for comparison.

It is another advantage of the present disclosure to use contract terms as filter criteria for group travel resources.

It is a further advantage of the present disclosure to automatically create contracts for group travel resources based on selected dates and corresponding pricing/rates for a given travel resource.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows a known travel resource planning document of a tour operator.

FIG. 2 is a diagram of an example group travel contracting system, according to an example embodiment of the present disclosure.

FIG. 3 is a diagram of an example procedure for creating a contract template, according to an example embodiment of the present disclosure.

FIGS. 4A and 4B are diagrams of an example procedure for creating a complete contract, according to an example embodiment of the present disclosure.

FIGS. 5A and 5B are diagrams that show dashboard user interfaces provided by an application on a tour operator device, according to an example embodiment of the present disclosure.

FIG. 6 is a diagram of a user interface of an application on a tour operator device displaying search results, according to an example embodiment of the present disclosure.

FIGS. 7 and 8 are diagrams that show filter criteria for search results in a user interface, according to an example embodiment of the present disclosure.

FIGS. 9 to 11 are diagrams of an example complete contract, according to an example embodiment of the present disclosure.

FIG. 12 is a diagram of a success message indicative that a completed contract has been transmitted to a travel resource provider for a counter-signature, according to an example embodiment of the present disclosure.

FIGS. 13A and 13B are diagrams of contract management dashboards provided by a server and displayed by an application of a tour operator device, according to an example embodiment of the present disclosure.

FIG. 13C shows a diagram of a user interface that provides a macro-view of a tour, according to an example embodiment of the present disclosure.

FIG. 14 is a diagram of a user interface with options for a user to select another city for creating contracts for travel resources, according to an example embodiment of the present disclosure.

FIGS. 15, 16A, and 16B are diagrams of user interfaces provided by a server for travel resource providers to create new contract term parameters or amend current contract term parameters for a contract template, according to an example embodiment of the present disclosure.

FIG. 17 is a diagram of another procedure for creating a contract, according to an example embodiment of the present disclosure.

### DETAILED DESCRIPTION

A system, methods, and apparatuses for automatically generating contracts for group travel resources are disclosed herein. Reference is made throughout to travel resources with embodiments focused on lodging. It should be appreciated that the system, methods, and apparatuses may be used for other group travel resources. For example, the system, methods, and apparatuses may automatically generate contracts for excursions, sight-seeing tours, motor coaches and other transportation, cruise boats, etc. In each end-use application, a travel resource provider has a discrete set of available units for a particular day (and in some instances at a particular location). The system, methods, and apparatuses are configured to electronically query the travel resource providers for availability of their units and corresponding pricing when they have a sufficient number of units for a requested date or range of dates. Further, the system, methods, and apparatuses are configured to create contracts for the travel resources using specified dates and corresponding pricing in conjunction with contract templates that already include pre-specified contract term parameters.

Reference is also made herein to contract templates. As discussed in more detail below, a contract template refers to a draft contract in which at least some contract term parameters are specified by a travel resource provider. The pre-specified contract term parameters are generally static or required for use of a travel resource of a provider. For example, the contract term parameters may include a cancellation period, an attrition percentage, a comp policy, a billing policy, a bed type, a parking policy, and a porterage policy. These contract term parameters are specified in the contract template in addition to more standard terms and conditions, such as arbitration clauses, choice of law clauses, etc. The contract templates also include sections that are configured to be populated with dynamic information, which may include dates, times, pricing, upgrades, and add-ons (e.g., selected amenities that have additional costs). Selection of the dynamic information by an online travel agency during a search process causes the system, methods, and apparatuses to add or populate the contract template with the dynamic information, thereby creating a completed contract. As disclosed herein, the completed contract is stored as an electronic file with electronic signature sections for the group travel operator/agency and the travel resource provider.

Reference is also made herein to a group travel or tour operator. As disclosed herein, a group tour operator is an individual or company that operates group travel for a plurality of individuals and/or families. Group travel operators select certain cities (or locations more generally) and dates for one or more tours and accordingly have to reserve travel resources such as lodging, excursions, transportation, etc. for those cities/dates. Since group travel operators do not own and operate their own travel resources, they have to contract with travel resource providers to reserve a needed number of travel resources in the specified city (e.g., a location, region, etc.) for the specified number of dates. The system, methods, and apparatuses are configured to provide an automated tool that enables group travel operators to search group travel resources and automatically generate contracts with providers of selected resources.

### I. EXAMPLE GROUP TRAVEL CONTRACTING SYSTEM

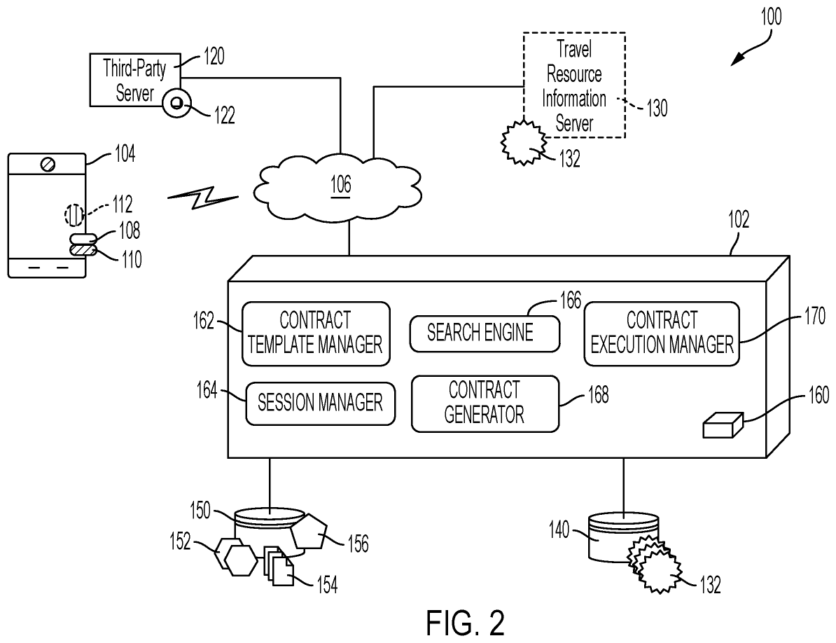

Turning to the figures, FIG. 2 is a diagram of an example group travel contracting system 100, according to an example embodiment of the present disclosure. The example system 100 includes a group travel contracting server 102, referred to herein as a server 102. The system 100 also includes one or more travel or tour operator devices 104, which is communicatively coupled to the server 102 via a network 106. While FIG. 2 shows a single tour operator device 104, it should be appreciated that the system 100 may include tens to thousands of tour operator devices 104.

The example tour operator device 104 may include a smartphone, a laptop computer, a tablet computer, a desktop computer, a workstation, etc. The tour operator device 104 includes a processor 108 and a memory device 110 (e.g., random access memory (“RAM”), read only memory (“ROM”), flash memory, magnetic or optical disks, optical memory, or other storage media) storing machine-readable instructions that define a software application 112. Execution of the instructions by the processor 108 causes the tour operator device 104 to operate the software application 112. In some embodiments, the software application 112 is a stand-alone (e.g., native) app with one or more interfaces for communicating with the server 102. Alternatively, the application 112 may include a web browser with one or more widgets or plugs that communicate with a website hosted or otherwise provided by the server 102.

The system 100 of FIG. 2 also includes one or more third-party servers 120. As disclosed herein, the third-party servers 120 are managed by travel resource providers. The third-party servers 120 are configured to manage travel resource inventory, availability, and/or unit/group pricing/rates. In some embodiments, the third-party servers 120 include reservation systems that include one or more application programming interfaces (“APIs”). The APIs are configured to receive structured query messages that identify, for example, a travel resource (e.g., a property name or identifier), a city, town, or region (e.g., a location name), an arrival date, a departure date, a number of units (e.g., rooms), etc. The third-party servers 120 are configured to perform a search query using the content of the query message as ingested through the APIs. The third-party servers 120 return an indication regarding an availability of the dates and corresponding pricing 122. In some embodiments, the third-party servers 120 may transmit an amount of available inventory for a given date and a corresponding price. Further, in some embodiments (as described in more detail below), the server 102 transmits a batch of inquiry messages, each message being for one stay (e.g., a resource usage date range) corresponding to an arrival date and a departure date. The third-party servers 120 provide a batch of response messages for each of the inquiry messages. In these embodiments, the server 120 is configured to aggregate the availability/inventory for each date range or stay to provide a summary for all the needed dates provided by the tour operator.

The network 106 may include a wide area network such as the Internet, a local area network, a cellular network, or combinations thereof. The tour operator device 104 may connect to the network 106 via a cellular connection, a Wi-Fi connection, an Ethernet connection, etc. The network 106 includes routers, switches, network appliances, etc. for routing communications between the tour operator devices 104, the third-party servers 120, and the server 102.

In some embodiments, the group travel contracting system 100 includes one or more travel resource information servers 130. As described in more detail below, the application 112 on the tour operator device 104 displays search results for travel resources. In the context of hotels, a user interface of the application 112 displays a list of properties. Each property in the list may be selected to show additional information about the property. The travel resource information server 130 is configured to provide content 132 for lists and additional information about the property. The content 132 may include at least one of available amenities (e.g., free breakfast, free Wi-Fi, pool, onsite bar, onsite restaurant, pet friendly, onsite parking, spa, etc.), a rating, a description, and/or one or more pictures related to the property/travel resource. The content 132 specifies how the certain text and/or graphics are to be arranged and displayed within the application 112. For example, certain text labeled as ‘description’ is inserted into a description field of a webpage or other interface that displays property information of a selected property.

In alternative embodiments, the content 132 may be provided by the third-party servers 120. In these embodiments, the third-party servers 120 may provide the content 132 in conjunction with the availability of the dates and corresponding pricing 122.

In yet further alternative embodiments, the content 132 is stored on a memory device 140 that is communicatively coupled to the server 102. The content 132 may be stored to the memory device 140 when a property or other travel resource is registered with the server 102 by a travel resource provider storing a contract template. The memory device 140 may include RAM, ROM, flash memory, magnetic or optical disks, optical memory, or other storage media.

As described in more detail below, the example server 102 is configured to transmit a call message to the travel resource information server 130, the third-party server 120, and/or the memory device 140 when content 132 for an identified property is needed. For instance, after receiving the availability of the dates and corresponding pricing 122 (indicating there is at least some availability/inventory for a property/travel resource), the server 102 transmits call messages to the travel resource information server 130, the third-party server 120, and/or the memory device 140 with an identifier of the travel resource/property. In response, the travel resource information server 130, the third-party server 120, and/or the memory device 140 provides the content 132 for displaying the search results.

The server 102 may also be communicatively coupled to another memory device 150 that is configured to store contract templates 152 and completed contracts 154. The contract templates 152 define certain pre-specified terms that are provided by a travel resource provider. At least some of the contract terms are parameters that may be used by the server 102 as filter criteria. The server 102 is configured to store a contract template 152 for each travel resource and/or each travel resource provider. In this manner, the memory device 150 stores an association between each contract template 152 and one or more travel resources. The association may be between an identifier of a specific contract template 152 and an identifier of the travel resource/property. A separate contract template 152 may be created for each hotel property. Alternatively, a travel resource provider may own ten different properties that have the same contract terms such that the same contract template 152 may be associated with each of the properties.

The completed contracts 154 comprise contract templates 152 that include specified dates and corresponding pricing for the travel resource/property. The completed contract 154 also specifies or identifies the property, the tour/travel operator/agency, and other information needed to formalize the contract. The completed contracts 154 may further include sections to receive electronic and/or wet signatures from both the travel operator and the travel resource provider.

The example memory device 150 is also configured to store one or more computer programs or components 156. The programs or the components 156 may be provided as computer instructions stored on any computer-readable medium. The instructions may be configured to be executed by a processor 160 of the server 102, which when executing the computer instructions 156, performs or facilitates the performance of all or part of the disclosed methods and procedures that are described herein.

FIG. 2 shows one example how the programs or the components 156 may be partitioned for operation on the server 102. In the illustrated example, the programs or the components 156 include a contract template manager 162, a session manager, a search engine 166, a contract generator 168, and a contract execution manager 170. In other embodiments, the programs or the components 156 may be combined together or further partitioned. For example, the contract generator 168 may be combined with the contract execution manager 170.

The contract template manager 162 is configured to provide for the creation of contract templates 152. In some embodiments, a travel resource provider may register with the server 102 to have their properties available. As part of this registration process, the contract template manager 162 transmits a blank contract template to the travel resource provider. This may include transmitting the blank contract template to the third-party server 120. The travel resource provider selects at least some static contract term parameters. The travel resource provider may also provide more general contract terms, such as choice of law provisions or other provisions that are specific to that provider. The travel resource provider transmits the completed contract template 152 to the contract template manager 162, which stores the contract template 152 to the memory device 150.

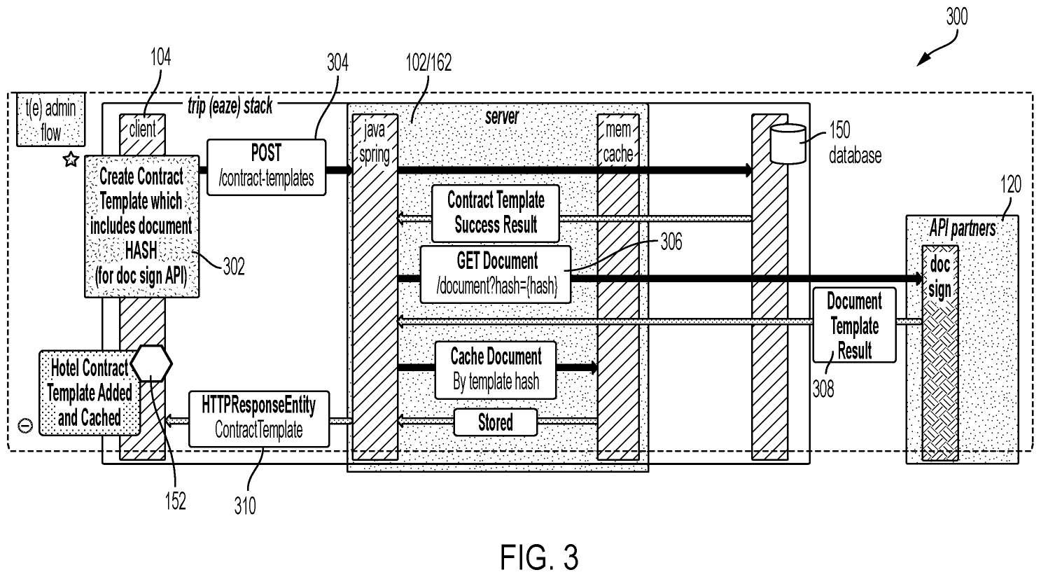

FIG. 3 is a diagram of an example procedure 300 for creating a contract template 152, according to an example embodiment of the present disclosure. Although the procedure 300 is described with reference to the flow diagram illustrated in FIG. 3, it should be appreciated that many other methods of performing the steps associated with the procedure 300 may be used. For example, the order of many of the blocks may be changed, certain blocks may be combined with other blocks, and many of the blocks described may be optional. The actions described in the procedure 300 are specified by one or more instructions 156 and may be performed among multiple devices including, for example the server 102 and/or the third-party server 120.

As shown, the contract template manager 162 is part of the server 102 stack and operates with the tour operator device 104 to provide for the creation of a blank contract template for a specific travel resource provider (block 302). The contract template manager 162 includes a document hash for a document sign API. The server 102 then stores the blank contract template to the memory device 150 via a post function (block 304). The memory device 150 transmits a success result message regarding the storage of the blank contract template. Further, the contract template manager 162 operates with the server 102 to provide the blank contract template to the third-party server 120 of the travel resource provider (block 306). The travel resource provider adds contract terms and signs off to create a contract template 152. As discussed above, the contract terms include certain parameters used for filtering and general contracting terms specific to that provider. The server 102 receives the contract template 152 from the server 120, which then stores the template 152 to an internal cache (block 308). Further, the server 102 uses the contract template manager 162 for making the contract template 152 available to the device 104, which may include storing the contract template 152 to the memory device 150 (block 310). At this point, the contract template 152 is ready for use and the example procedure 300 ends.

Returning to FIG. 2, the server 102 includes the session manager 164 for handling sessions with each of the devices 104. The application 112 on each device 104 provides interfaces for receiving group travel search parameters and displaying search results. The session manager 164 maintains separate sessions between the server 102 and the devices 104 to ensure the right device 104 receives the correct search result information. Further, the session manager 164 may provide authentication to ensure only registered group tour/travel agencies have access to the server 102.

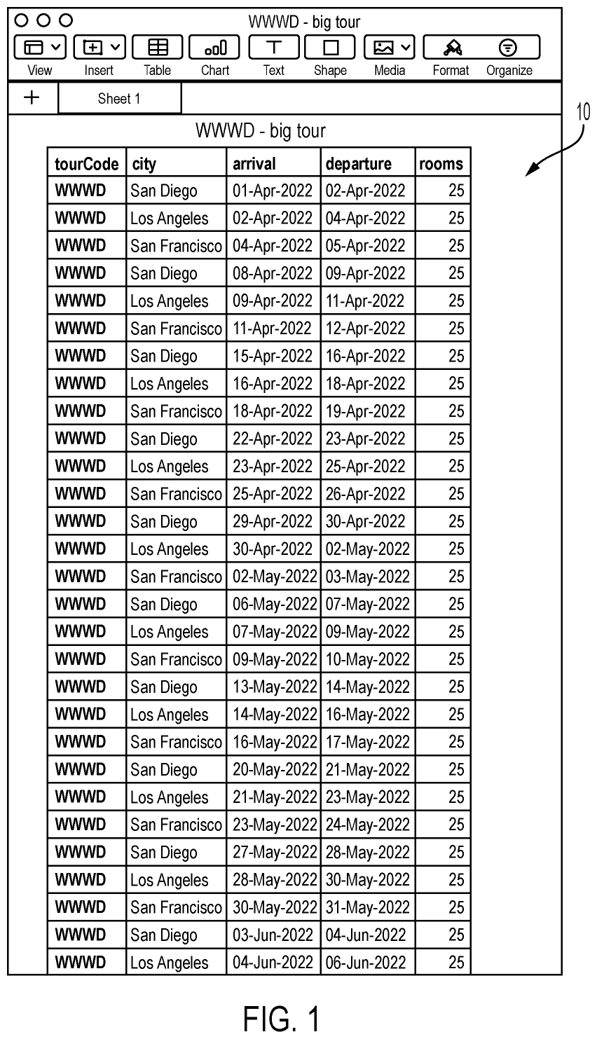

The example search engine 166 of the server 102 is configured to parse a travel resource planning document 10 from the device 104 and/or otherwise receive group travel search parameters for generating one or more queries. As discussed in more detail below, the search engine 166 is configured to parse the document 10 or otherwise prompt a tour operator via the application 112 for cities/locations, date ranges for each city, and a number of individuals or pairs for each date range/city pair. In the example of FIG. 1, the search engine 166 is configured to parse the cities of San Diego, Los Angeles, and San Francisco into separate groups. The search engine 166 then identifies and aggregates the separate arrival and departure dates for each parsed city to create resource usage date ranges. In this example, the search engine 166 aggregates the dates of Apr. 1, 2022, Apr. 9, 2022, Apr. 16, 2022, Apr. 23, 2022, Apr. 30, 2022, May 7, 2022, May 14, 2022, May 21, 2022, May 28, 2022, and Jun. 4, 2022 for the parsed city of San Diego. Further, the search engine 166 uses the number of rooms/units as a search parameter in some instances.

In this example, the search engine 166 creates one or more request or inquiry messages for the third-party servers 120 that include the parsed city of San Diego, the aggregated dates, and the number of rooms. A single message may include all of the above-dates, which causes the servers 120, when configured, to perform a separate search for the separate dates. Alternatively, the search engine 166 transmits a separate request or inquiry message for each of the separate dates. Further, in the above-example, the stay range is one day. In other examples, the stay range is two or more days. In these examples, the request includes the arrival date and the departure date or the arrival date and the number of stay days.

In response to the search request, the servers 120 provide a price (when the full amount of rooms are available) for each of the aggregated dates for the specified number of rooms for their managed travel resources/properties. For stays with more than one night, the price may include an average price per night or a separate price for each of the days during the single stay. When the servers 120 cannot provide availability information, the servers 120 may provide a response message that includes a price and an amount of inventory for each of the dates for their managed travel resources/properties. In these alternative embodiments, the search engine 166 compares the inventory to the number of specified rooms to determine availability. For the dates with availability, the search engine 166 causes the application 112 on the device 104 to display the dates and corresponding prices for the respective properties/travel resources.

In addition to above, the example search engine 166 in conjunction with the session manager 164 is configured to ensure that all dates/cities of the travel resource planning document 10 are processed. This includes tracking which cities/dates have been specified in a contract and which dates and/or cities still need to be contracted. The search engine 166 may cause a user interface of the application 112 to display cities and/or dates for which a contract has not yet been generated. Further, the search engine 166 may remove dates from search results (or provide an indication of a contract already in place) after contracts for those dates/cities have been generated.

The server 102 of FIG. 2 also includes the contract generator 168 for creating a complete contract 154 after a group travel/tour operator selects one or more dates for a particular property or other travel resource. The contract generator 168 receives from the application 112 the selected property, for example, which is identified by a travel resource identifier. The contract generator 168 also receives selected dates or stay ranges and corresponding rates/pricing. The contract generator 168 uses the property identifier to access the corresponding contract template 152 from the memory device 150. The contract generator 168 then applies the selected dates or stay ranges and corresponding rates/pricing to the contract template 162 to create the complete contract 154, which is stored as a file to the memory device 150. The contract generator 168 may also include property details, such as a property name, address, and/or contact information. Further, the contract generator 168 adds a name, addresses, and/or contact information of the travel/tour operator, which may be provided by the session manager 164 and/or the application 112. The contract generator 168 also adds or otherwise enables e-signature sections for the travel resource provider and the tour operator.

The example contract execution manager 170 is configured to manage the electronic and/or wet signing of the contract files 154. After a new contract 154 is stored to the memory device 150, the contract execution manager 170 transmits the contract 154 to the device 104 for display in the application 112. If acceptable, the group tour operator electronically signs the contract 154 via the application 112. The contract execution manager 170 stores the signed contract 154, including a date of signature, to the memory device 150. The contract execution manager 170 then uses contact information, such as an email address on the contract 154, to transmit the contract 154 to, for example, the appropriate third-party server 120 or an email address related to a travel resource provider that is related to one of the third-party servers 120. The contract execution manager 170 later receives a response message including the signed contract from the travel resource provider, which is then stored to the memory device 150.

In some embodiments, a travel resource provider may provide a wet signature on a hardcopy of the contract 154. In these embodiments, the contract execution manager 170 receives an image file of the signed contract 154 for storage in the memory device 150.

Further, in some embodiments, the contract execution manager 170 operates a timer for each transmitted contract. When a specified time threshold has been reached before a signed contract has been returned, the contract execution manager 170 is configured to transmit one or more reminder messages. The time threshold may be an hour, four hours, twelve hours, twenty-four hours, forty-eight hours, one-week, etc.

### II. EXAMPLE GROUP TRAVEL RESOURCE CONTRACTING EMBODIMENT

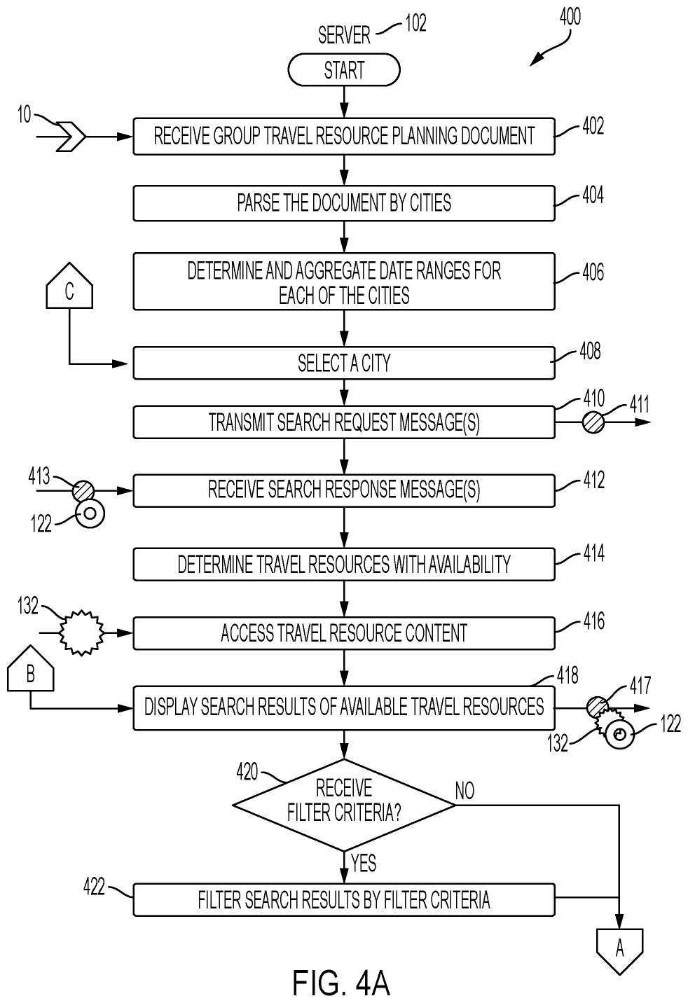

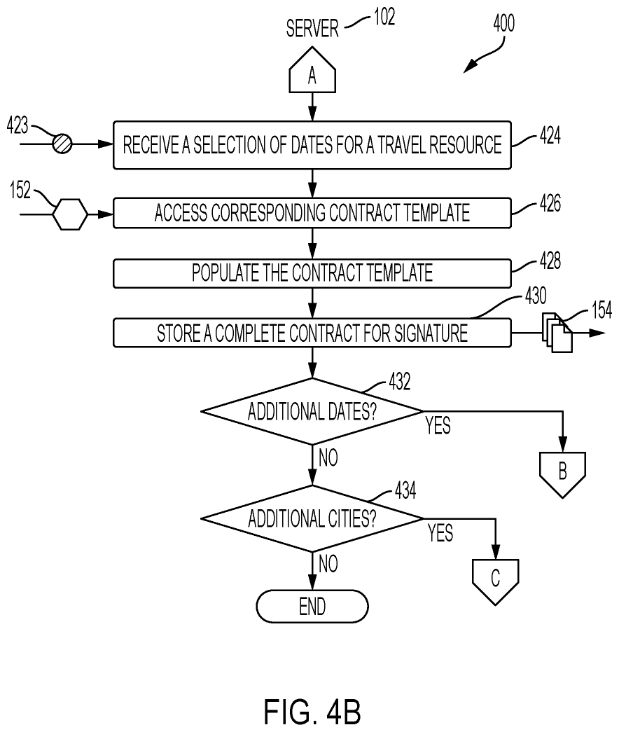

FIGS. 4A and 4B are diagrams of an example procedure 400 for creating a complete contract 154, according to an example embodiment of the present disclosure. Although the procedure 400 is described with reference to the flow diagram illustrated in FIGS. 4A and 4B, it should be appreciated that many other methods of performing the steps associated with the procedure 400 may be used. For example, the order of many of the blocks may be changed, certain blocks may be combined with other blocks, and many of the blocks described may be optional. The actions described in the procedure 400 are specified by one or more instructions 156 and may be performed among multiple devices including, for example the server 102, the tour operator device 104, and/or the third-party server 120.

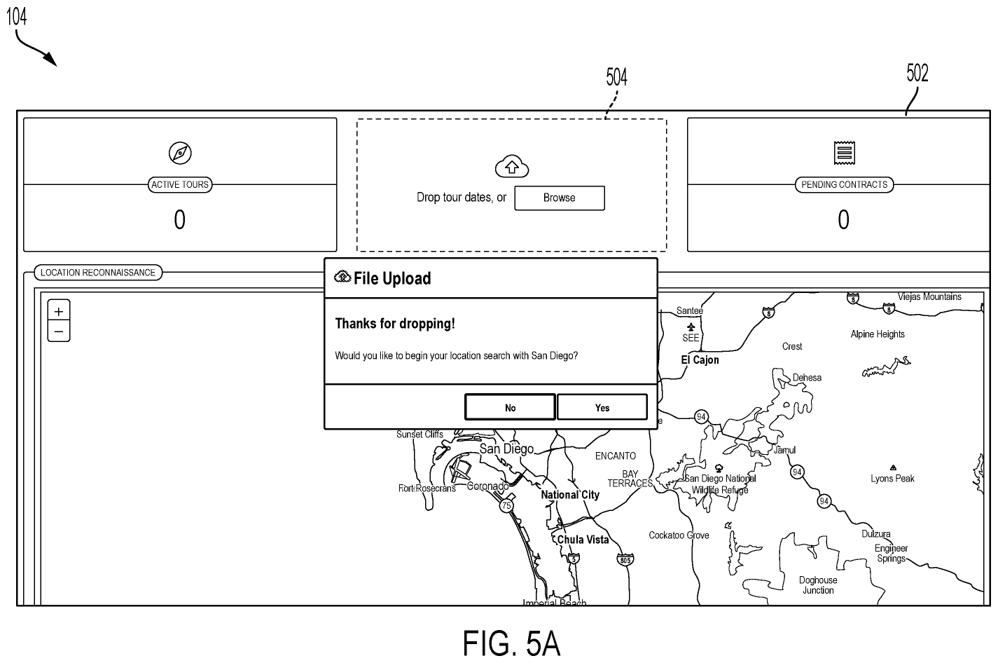

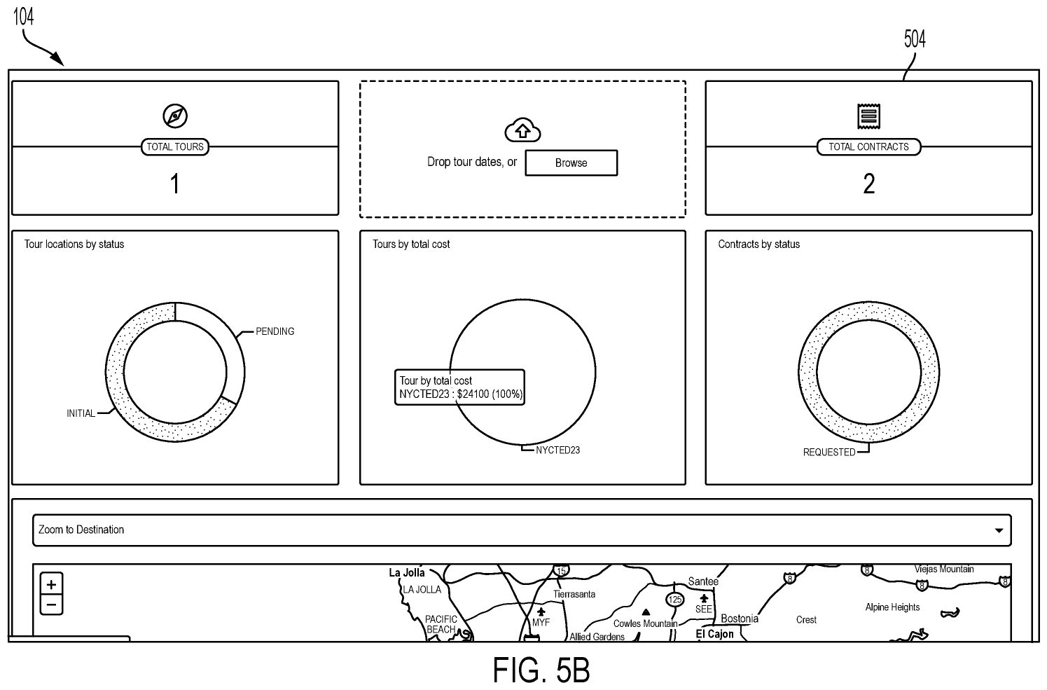

The procedure 400 begins when the server 102 receives a group travel resource planning document, such as the document 10 shown in FIG. 1 (block 402). In other embodiments, the server 102 prompts the tour operator via the application 112 on the device 104 for a tour schedule, itinerary, or parameters that specify desired cities/locations, dates for each city, and a number of units needed. FIG. 5A is a diagram that shows a user interface 502 provided by the application 112 on the tour operator device 104, according to an example embodiment of the present disclosure. The user interface 502 includes an area for receiving the group travel resource planning document 10. Alternatively, a user may select a ‘browse’ feature to search though a file directory to locate the document 10. As an added convenience, the user interface 502 displays a map that shows at least one of the cities or regions specified in the document 10. Additionally or alternatively, the user interface 502 may include a section for a user to enter cities and corresponding dates and a number of units.

FIG. 5B is another diagram that shows a user interface 504 provided by the application 112 on the tour operator device 104, according to an example embodiment of the present disclosure. The user interface 504 includes additional reporting dashboard widgets including a status of tour locations, tour costs, and a contract status. The user interface 504 (populated by the server 102) provides a tour operator with a macro-view snapshot of a status of all cities or locations in a tour in conjunction with the corresponding cost. As discussed above, each location includes a destination, an arrival/departure date, number of rooms, a total room nights, a budgeted rate, a total budgeted cost, an actual rate, a total actual cost, and a status.

Returning to FIG. 4A, the example server 102 next parses contents of the document 10 (or information provided by the tour operator) by city or region (block 404). The server 102 also analyzes the arrival and departure date for each city to create a resource usage date range (block 406). For a single day (night) stay, the resource usage date range includes the arrival date and the next day departure date. For a multiple day stay, the resource usage date range includes the arrival date, the departure date, and the dates therebetween. In some embodiments, the date range may be specified by the arrival date and the number of days (nights). The server 102 aggregates the date ranges for each city, as discussed above in connection with the search engine 166 of FIG. 2.

The example server 102 may then select one of the parsed cities (block 408). In other examples, the server 102 may provide a prompt via the application 112 for the group tour operator to select one of the parsed cities. The server 102 next creates one or more request messages 411 with search parameters. The search parameters include a city (or region) name, the aggregated date ranges, and the number of units needed for each date range. In some embodiments, the search parameters may also include contract term parameters, neighborhoods, a minimum/maximum rating, a minimum/maximum unit price/rate (or aggregate price/rate), amenity types, etc. The request message 411 may also include a discount code and/or membership reward number. The example server 102 transmits the one or more request messages 411 to the third-party servers 120 (block 410). As discussed above, the server 102 may transmit the request messages 411 to APIs of the third-party servers 120 for performing travel resource availability searches.

In some instances, the server 102 creates a separate request or search inquiry message 411 for each date range in the aggregated data ranges for a given parsed city. Each request message 411 is configured to trigger a separate search of the third-party servers 120 for the specified date range. In these embodiments, the third-party servers 120 are not capable of or do not include an API for receiving multiple date ranges.

The example procedure 400 continues when the server 102 receives one or more response messages 413 from the third-party servers 120 (block 412). The response messages 413 provide availability and/or inventory information for the specified date ranges and number of specified units for a given property/travel resource (e.g., the availability of the dates and corresponding pricing 122 of FIG. 2). In instances where the servers 120 can handle multiple date ranges, the messages 413 may indicate an availability and/or price/rate for each date range for a given property. In instances where the servers 120 can only process a single date range, separate response messages 413 are received that each indicate an availability and/or price/rate for a specific date range associated with a given property. Further, the messages 413 may specify if the property has availability based on the number of specified units for each date range. Alternatively, the response message 413 may include a number of available inventory. In these alternative embodiments, the server 102 compares the inventory number to the requested number of units for each date to determine availability.

As shown in FIG. 4A, the server 102 next determines availability for each property or travel resource for which a response message 413 was received (block 414). As mentioned above, the message 413 may include an indication of availability or the server 102 determines availability for each date range for a given property based on the received room/unit inventory amount. For each of the travel resources/properties with availability for at least one date range, the server 102 accesses or otherwise obtains travel resource information (e.g., the content 132 of FIG. 2) that is related to the travel resource including text and graphics (block 416). The server 102 uses the received content 132 for each property with availability to display search results 417 in the application 112 of the tour operator device 10 (block 418). The displayed search results 417 includes the content 132 and the availability of the dates and corresponding pricing 122.

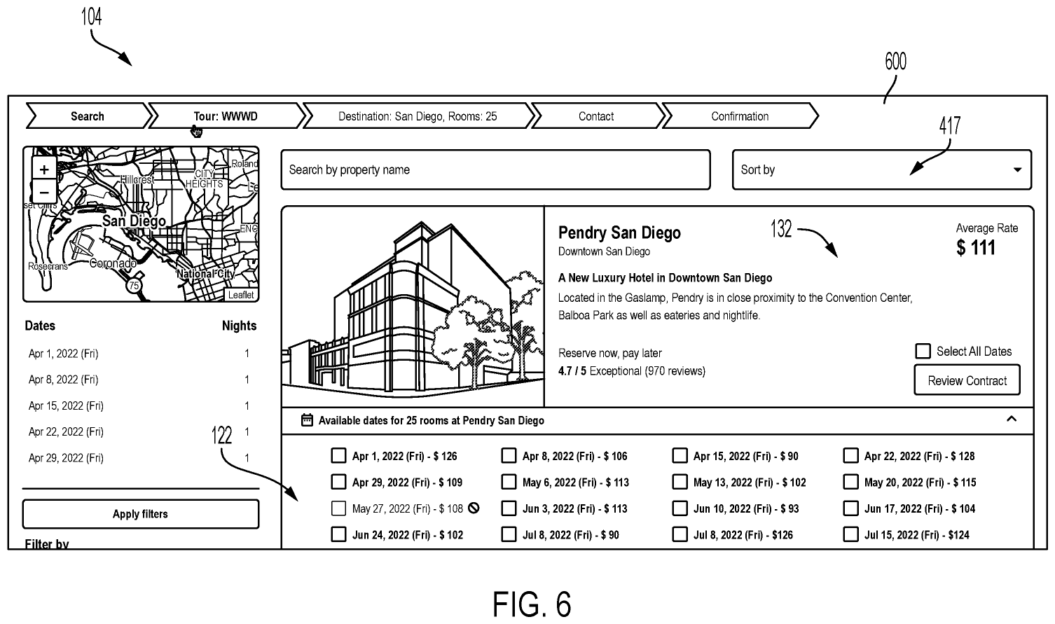

FIG. 6 is a diagram of a user interface 600 of the application 112 on the tour operator device 104 displaying the search results 417, according to an example embodiment of the present disclosure. The search results 417 are provided as an ordered lists of properties. A travel operator uses a scroll feature on the application 112 to view additional properties. The server 102 may arrange the properties based on an average rate for all the dates with availability for each property. The server 102 may alternatively order the properties based on which ones have the most available date ranges. As shown in FIG. 6, the user interface 600 includes a “Sort by” option to enable the tour operator to select how the properties are arranged or listed by the server 102.

For each property, the user interface 600 includes the content 132, which is text and images for the property. The content 132 may also include a rating, user reviews, and any other information or multimedia for conveying information about a travel resource. The user interface 600 also includes a section that shows the availability of the dates and corresponding pricing 122 for the number of units specified in the search (e.g., 25 rooms). This graphical interface is extremely helpful for a user since it shows whether each specified date rate is available, and if so, the corresponding pricing. Further, the section for the availability of the dates and corresponding pricing 122 includes selection boxes that the tour operator may select if only a certain portion of dates is selected. If only a subset of the date ranges are selected, the server 102 (or the application 112) is configured to calculate an average rate for only the selected date ranges. Alternatively, the tour operator can select in the user interface 600 an option that chooses all the available dates or date ranges.

In some embodiments, the user interface 600 may be modified such that exception dates are not shown with the available dates in the pricing section 122. Instead, the user interface 600 may provide selectable text that indicates or highlights which dates have exceptions. The selectable text may be provided above the ‘Select All Dates’ button within the user interface 600. Upon selecting the text, a window or other graphical feature is displayed that shows the exception date ranges and/or a message about where to view and manage the exception date ranges.

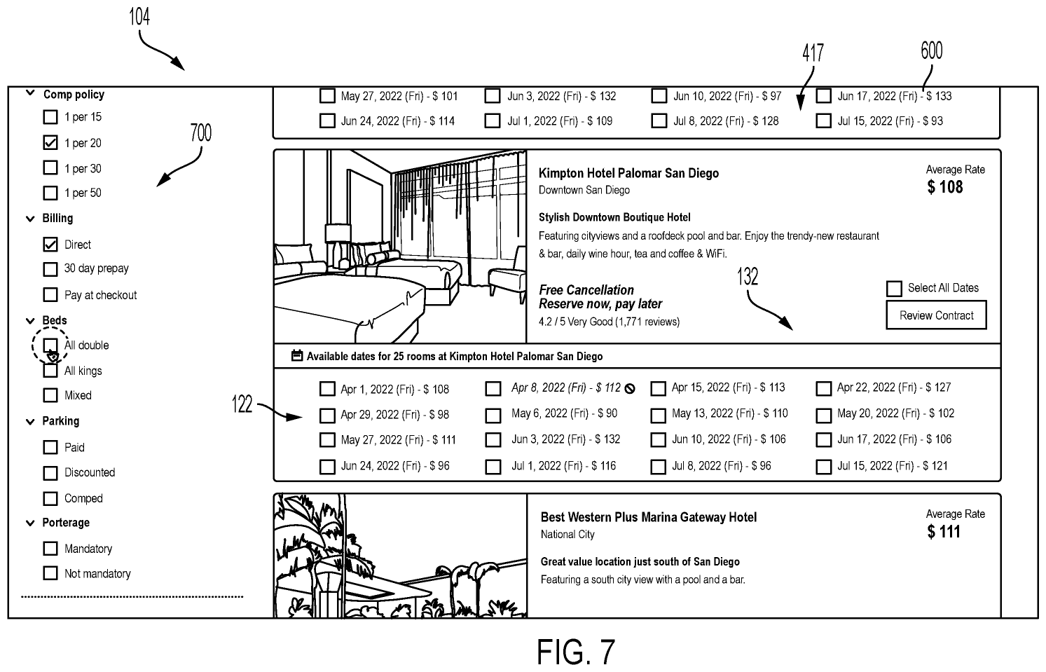

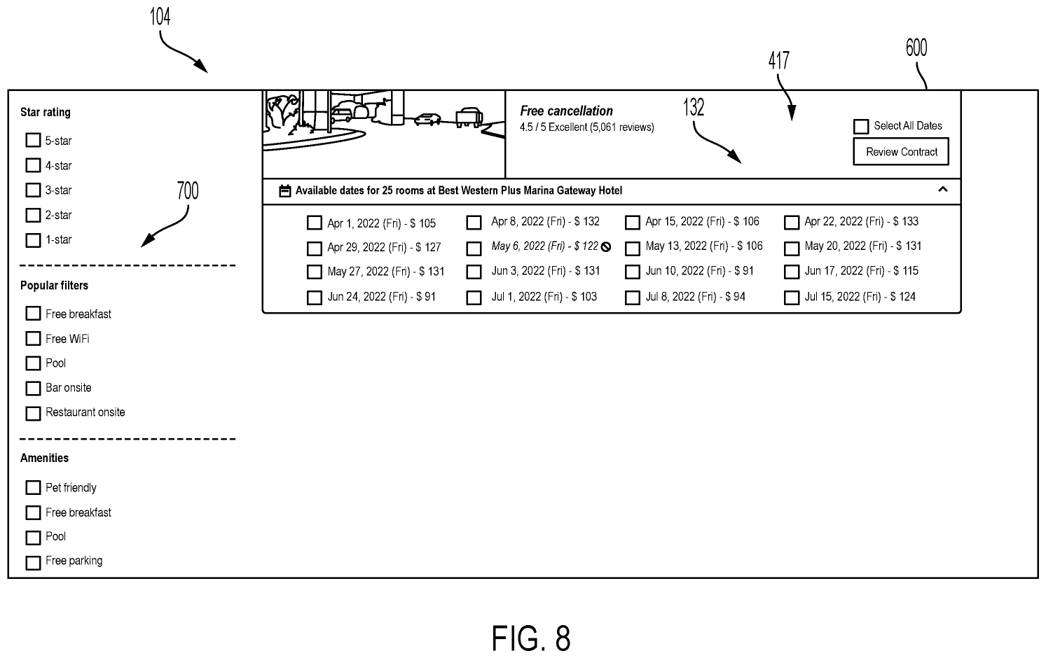

Returning to FIG. 4A, the server 120 determines if any filter criteria is selected (block 420). FIGS. 7 and 8 are diagrams that show filter criteria 700 for the search results 417 in the user interface 600, according to an example embodiment of the present disclosure. FIG. 7 shows that the tour operator has scrolled down to another property with its own content 132 and availability of the dates and corresponding pricing 122. The left side of the user interface 600 shows filter criteria 700. In FIG. 7, the filter criteria 700 includes contract term parameters including a comp policy, a billing policy, a bed policy, a parking policy, and a portage policy. A user may select one or more of the contract term parameters listed within the filter criteria 700. This selection causes the server 102 to determine which of the listed properties match the desired contract terms. Instead of sending another request to the servers 120, the server 102 instead accesses the contract templates 152 that are stored in the memory device 150 for the listed properties. The server 102 analyzes the contract templates 152 to determine which contract term parameters are specified. In alternative embodiments, the memory device 150 stores a list of which contract terms from the user interface 700 are included in each contract template 152. In these alternative embodiments, the server 102 accesses the list to determine which properties should be filtered based on the selected contract filter criteria 700. Properties that have contract templates 152 that match the selected filtered criteria 700 are selected by the server 102 to remain in the search results 417 while those properties that do not have matching contract term parameters are removed from the search results 417 by the server 102. In this manner, the server 102 enables a tour operator to filter properties by certain, desired contract terms without having to manually review individual contracts.

FIG. 8 is a diagram that shows additional non-contract term filter criteria 700. For example, the user interface 600 may include options to filter by a star rating, a user rating, amenities, etc. To filter the properties, the server 102 may accesses the content 132 for each property, which usually includes lists or text specifying the amenities. The server 102 performs text matching, for example, to determine which properties have the selected amenity or rating filter criteria 700. The server 102 accordingly selectively excludes properties that do not match the specified filter criteria 700. In alternative embodiments, the memory device 150 stores a list of amenities or other filter criteria for each property so that the content 132 does not have to be searched. The list may include, for example, a star rating for a property, which of the popular filters are present at the property, and which amenities are present at the property.

Returning to FIG. 4A, when the filter criteria 700 is selected, the server 102 filters the search results 417 by the filter criteria, as discussed above (block 422). The procedure 400 continues in FIG. 4B where the server 102 receives one or more messages 423 from the application 112 on the device 104 indicative of selected date ranges for a property or travel resource (block 424). For example, using the property shown in FIG. 6, a user may select some or all of the date ranges, then select the “Review Contract” option in the user interface 600. Selection of the “Review Contract” option causes the application 112 to transmit the selected date ranges and/or corresponding prices to the server 102. The message 434 also includes an identifier of the property or travel resource. The server 102 next accesses the memory device 150 and selects the contract template 152 that corresponds to the identifier of the property or travel resource (block 426).

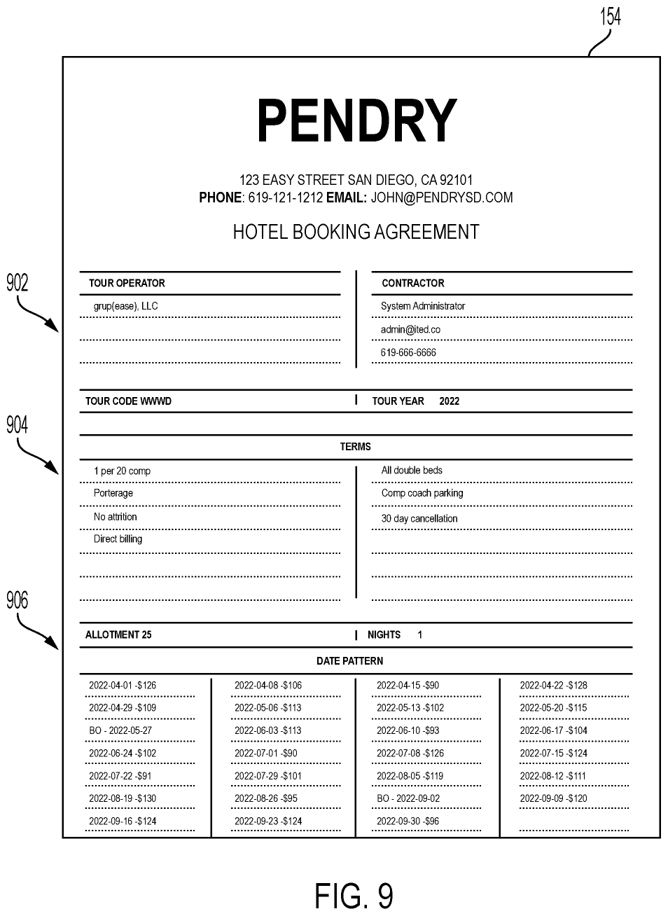

The server 102 then populates or edits the contract template 152 by adding the selected dates and corresponding prices for a selected property or travel resource (block 428). The server 102 may also add a name, an address, and/or contact information for the corresponding tour operator. FIGS. 9 to 11 are diagrams of an example complete contract 154, according to an example embodiment of the present disclosure. The completed contract 154 is an electronic file that represents a legal agreement between a travel resource provider and a tour operator. As shown in FIG. 9, the contract 154 includes a name of the property and contact information of the property. This information may be included with the contract template 152 or added by the server 102 after selection when a travel resource provider has one contract template for multiple properties. The contract 154 also includes a section 902 with the tour operator information including contact information, a tour code, and a tour year. This information may be parsed from the document 10 and/or provided by the session manager 164 based on which user is logged into the system via the device 104.

The contract 154 also includes contract term parameters 904. As discussed above, the contract term parameters 904 are set or pre-specified in advance by the travel resource provider when the contract template 152 is created. In some embodiments, the server 102 may enable a travel resource provider to periodically amend the terms 904 on the template contract 152.

The contract 154 further includes a date and pricing section 906. As shown, the date and pricing section 906 specifies a number of units or rooms. The date and pricing section 906 also includes the separate date ranges selected by the tour operator via the user interface 600. The section 906 further includes the corresponding pricing for each date. The date and pricing section 906 is added by the server 102 to create the complete contract 154. In some embodiments, the pricing section 906 may display both arrival and departure dates in conjunction with the corresponding contract total room cost, which is the aggregate of the room costs for each day within the arrival and departure date range.

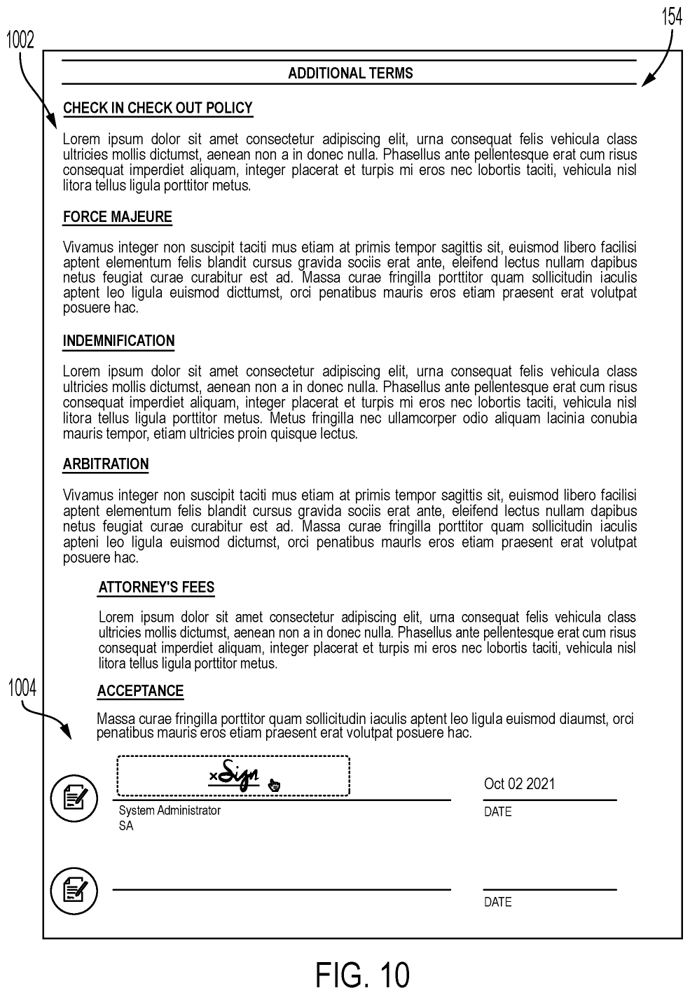

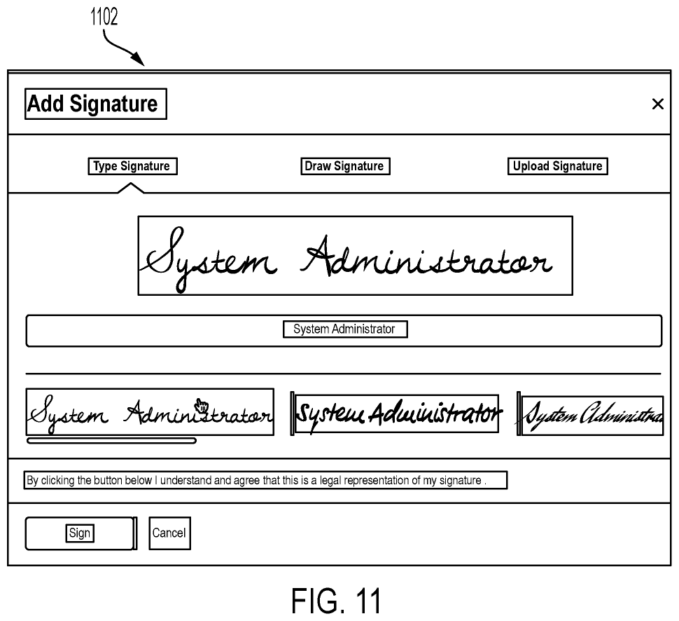

FIG. 10 shows that the contract 154 also includes standard terms 1002 that are specific to the travel resource provider. As discussed above, these terms are agreed to in advance between the travel resource provider and an operator of the server 102 and/or a tour operator. The contract 154 further includes a signature section 1004 for receiving an electronic and/or wet signature. The contract 154 may include embedded code to provide for an electronic signature 1102, as shown in FIG. 11.

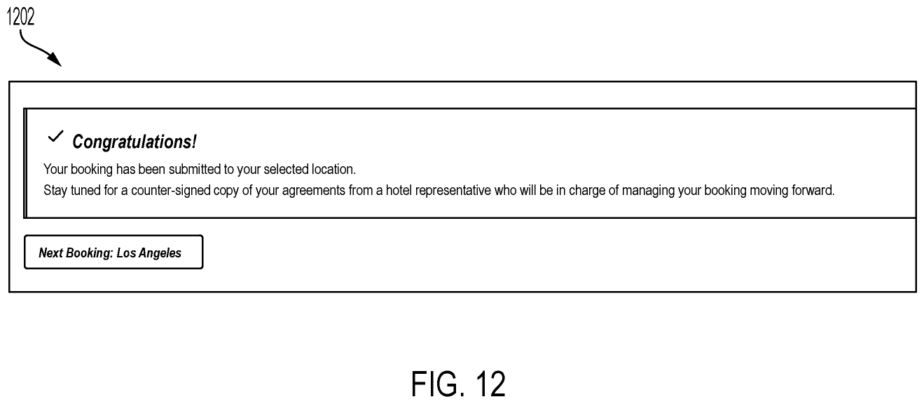

Returning to FIG. 4B, after the contract 154 is created, the server 102 stores the contract 154 to the memory device 150 (block 430). Further, the server 102 provides the contract 154 for a signature of the tour operator via the application 112 on the device 104. When the signature of the tour operator is received, the server 102 may display a success message 1202, as shown in FIG. 12. The success message 1202 indicates that the server 102 has transmitted the contract 154 to the travel resource provider for a counter-signature to finalize the contract 154. The server 102 later receives the counter-signed contract 154, which is also stored to the memory device 150.

In some instances, the server 102 transmits one or more reservation messages to the server 120 of the travel resource provider to reserve/book the number of contracted units for the contracted date ranges at the contracted price when the counter-signed contract 154 is received. Alternatively, the travel resource provider manually or automatically handles the reservation and booking of the units when they counter-sign the contract 154. In either instance, the server 102 may track when date ranges for the specified cities are reserved or otherwise booked.

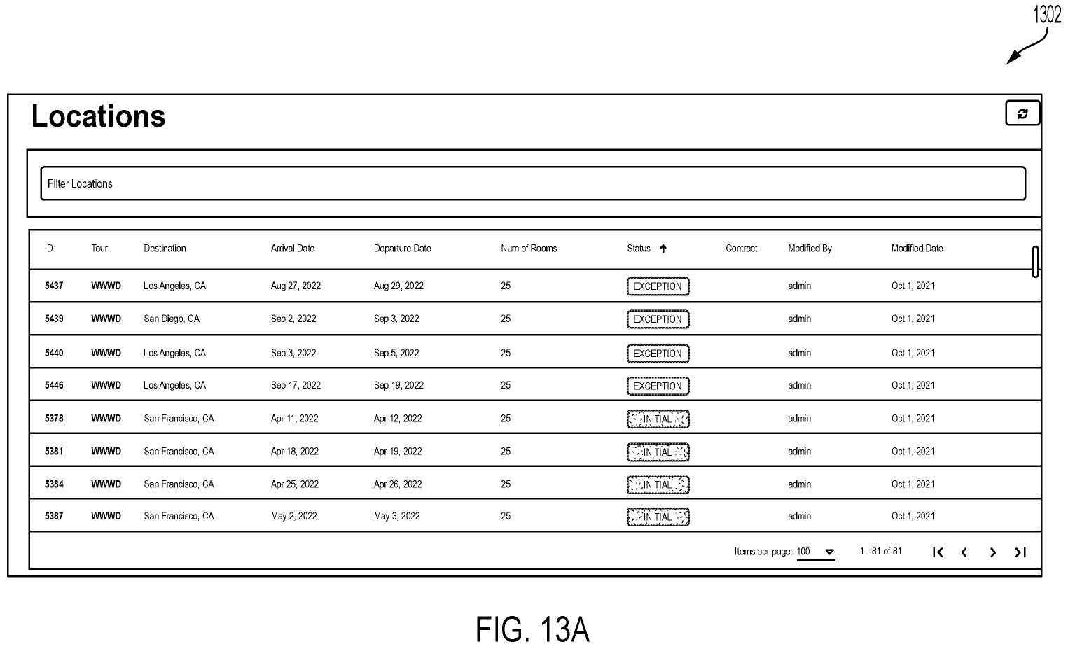

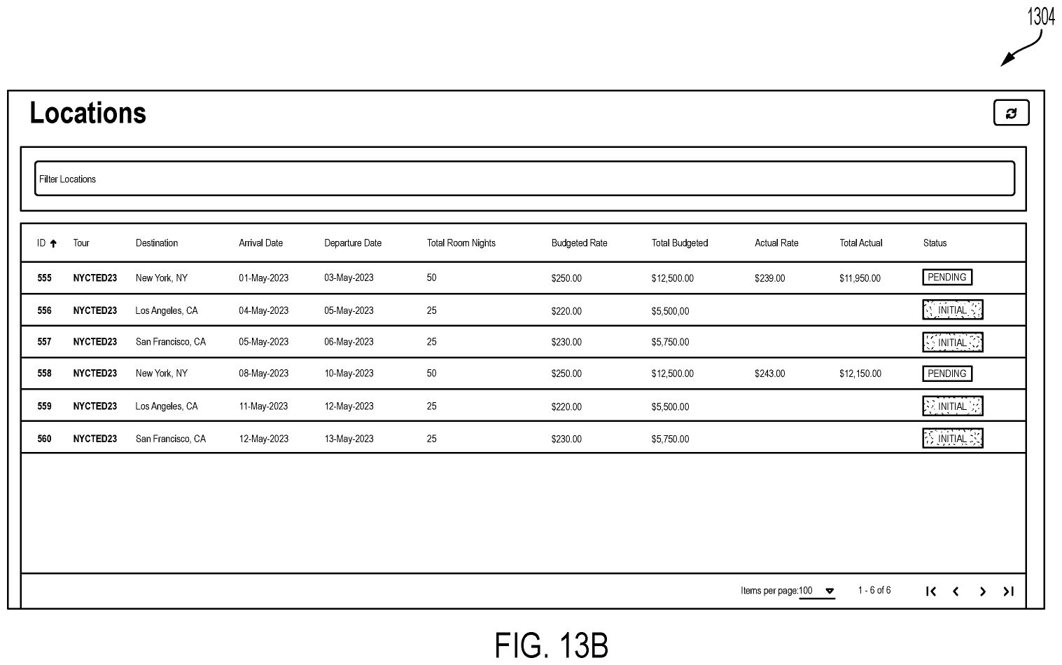

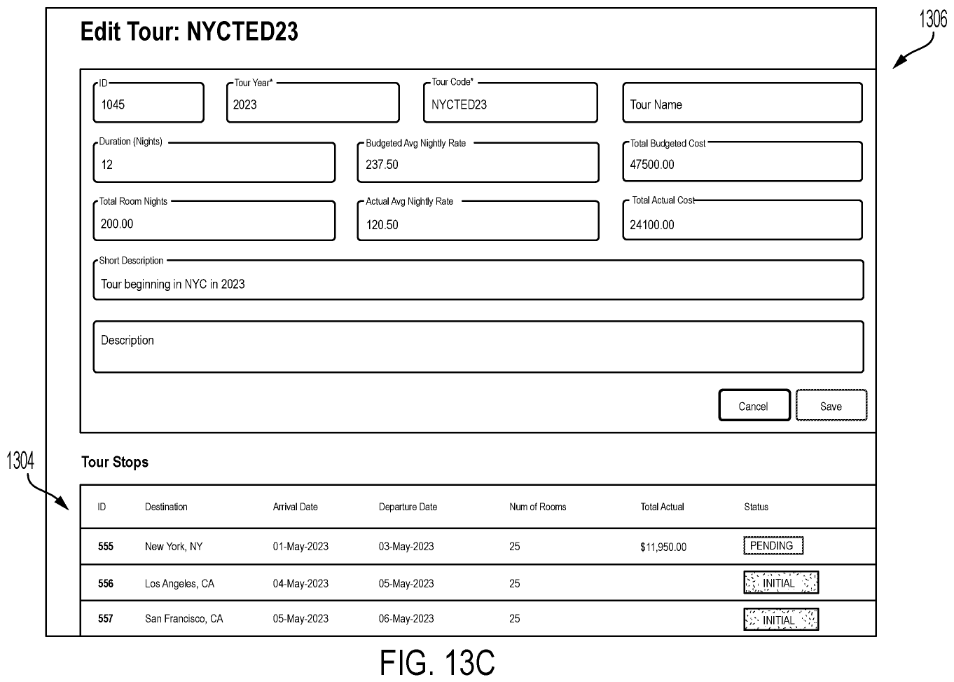

The example procedure 400 of FIG. 4B continues after the contract 154 is created and/or signed by the tour operator. As shown, the server 102 may also determine if there are additional dates of the same city (block 432) and/or additional cities (block 434) that have not yet been contracted. For instance, FIG. 13A is a diagram of a dashboard 1302 provided by the server 102 and displayed by the application 112 of the tour operator device 104, according to an example embodiment of the present disclosure. The dashboard 1302 provides a summary for each date range indicating whether a property has been selected, a contract has been created, a contract has been signed, or a contract has been finalized.

FIG. 13B is a diagram of another dashboard 1304 that may be provided by the server 102 and displayed by the application 112 of the tour operator device 104, according to an example embodiment of the present disclosure. The dashboard 1304 includes a budgeted rate that may be specified by a tour operator using the application 112 or via the document 10 of FIG. 1. The server 102 calculates a total budgeted value by multiplying the budgeted rate by the total room nights. The dashboard 1304 also includes an actual rate. The server 102 determines the actual rate from the pricing 122 that was selected and included within the contract 154. The server 102 also calculates the actual total by multiplying the actual rate by the number of room nights. The status indicates whether the contract 154 has been signed and counter-signed and/or whether the rooms have been reserved. The dashboard 1304 gives tour operators the ability to track the costs for each location to ensure a given tour is within budget. In some embodiments, the server 102 enables the information shown in the dashboard 1304 to be exported to a spreadsheet or other accounting/finance program.

As shown in FIGS. 4A and 4B, the tour operator may return to the user interface 600 to display the search results 417. The server 102 returns to block 418 and may adjust the search results 417 by removing the dates in the pricing section 122 of each property for which a contract 154 has already been created. In some instances where the removed dates correspond to the only available dates for a property, the server 102 may remove the property from the search results 417 so that only properties with availability for the remaining date ranges are shown. The tour operator may then select one or more properties for the remaining date ranges and cause the server 102 to create the corresponding contracts for signature.

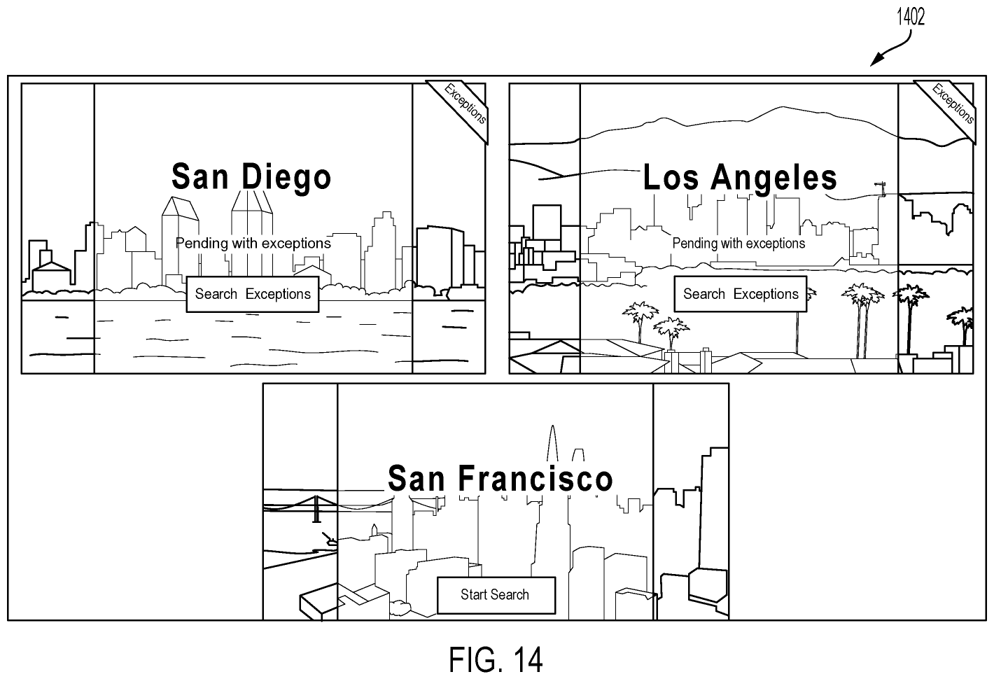

FIGS. 4A and 4B also show that when date ranges for one city are completely contracted, the server 102 returns to block 408 and selects or receives a selection of another city that is included within, for example, the document 10 of FIG. 1. FIG. 14 is a diagram of a user interface 1402 with options for a user to select another city for creating contracts for travel resources, according to an example embodiment of the present disclosure. In some embodiments, the server 102 may automatically select another city, as shown in FIG. 12, where an option to book for Los Angeles is provided. The example server 102 continues the procedure 400 until all date ranges for all specified cities are contracted. The example procedure 400 then ends.

### III. ADDITIONAL GROUP TRAVEL CONTRACTING EMBODIMENTS

Returning to FIG. 6, the section for the dates and corresponding pricing 122 of the user interface 600 shows certain dates as being unavailable. For example, May 27, 2022 is shown as not being available. These unavailable dates are referred to as exceptions, where the total number of needed units/rooms are not available or the date falls on holiday or other specially designated day that is outside the terms of the contract template 152.

By tracking which dates/cities are contracted, the server 102 enables a tour operator to contract for dates that may be designated as exceptions for many properties. The dashboard 1302 of FIG. 13 shows which dates correspond to exceptions and have not yet been contracted. Further, the user interface 1402 provides an option to search properties for the dates that are designated as exceptions. Selection of one of these options by the tour operator causes the server 102 to perform a search, as described above, using only the un-contracted date ranges for the specified city that correspond to the exception. Response messages 413 received by the server 102 from the third-party servers 120 provide pricing and availability for these exception dates. The search results 417 displayed by the server 102 in the application 112 on the device 104 accordingly only shows properties that have availability for at least one of the exception dates. In some instances, a different, second contract template 152 may be used for exception dates when a travel resource provider created such a contract template. Alternatively, the server 102 may use the designated contract template 152 for the properties that have availability for at least one of the exception date ranges.

After the exception dates for a city are contracted, the dashboard 1302 of FIG. 13 shows the corresponding status for those dates. It should be appreciated that the dashboard 1302 and other status indicators provided by the server 102 relate to individual date ranges for each of the cities. In other words, the dashboard 1302 provides visibility for a tour operator as to which date ranges are contracted and which other date ranges are not yet contracted. This visibility enables a tour operator to select date ranges/cities that have not yet been contracted to ensure that all date ranges are eventually contracted.

FIG. 13C shows a diagram of a user interface 1306 that provides a macro-view of a tour, according to an example embodiment of the present disclosure. The user interface 1306 specifically displays a summary of the costs relative to budgeted costs for each location of a tour. The user interface 1306 may be displayed after a user selects a city or location row in the user interface 1304 of FIG. 13B via the application 112. The costs and budgeted costs are obtained by the server 102 as discussed in conjunction with FIG. 13B. The user interface 1306 accordingly provides a tour operator with useful information regarding how well a tour is conforming to an expected budget.

As discussed above, the example server 102 automatically generates contracts for travel resources. In some embodiments, the server 102 also causes selected travel resources to be locked-in or otherwise reserved. For example, after a contract 154 is signed by a tour operator and transmitted to the travel resource provider, the server 102 may send one or more reservation messages to the server 120 of the travel resource provider. The reservation messages identify the property, the date ranges, the pricing, contact information of the tour operator, a membership number, and/or payment information. The reservation messages may be transmitted to one or more APIs of the server 120 to provide for an automatic reservation for the contracted number of units/rooms at the contracted price for the contracted date ranges. The reservation messages cause the server 120 to block out, lock-in, or otherwise reserve the rooms or units of travel resource. This configuration prevents the units from being sold to other parties while the contract 154 is waiting to be counter-signed.

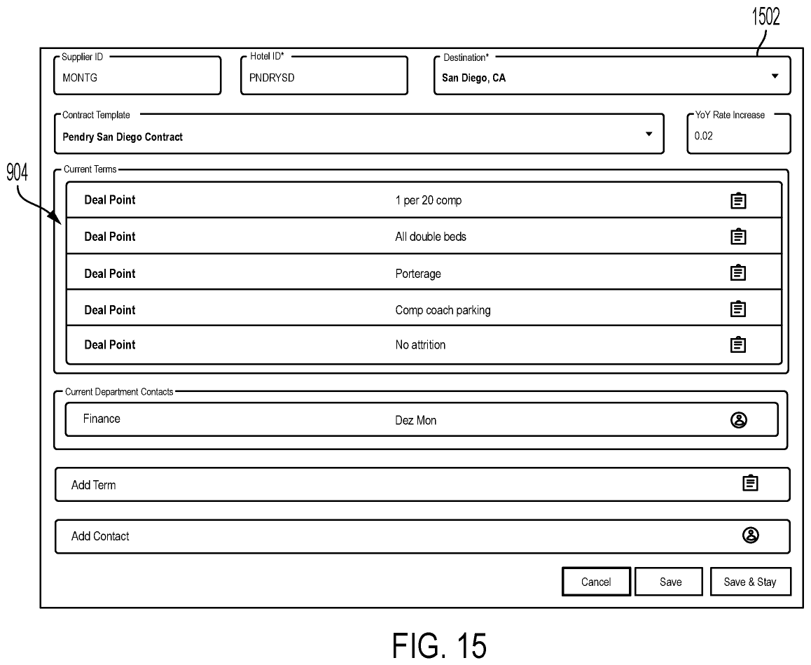

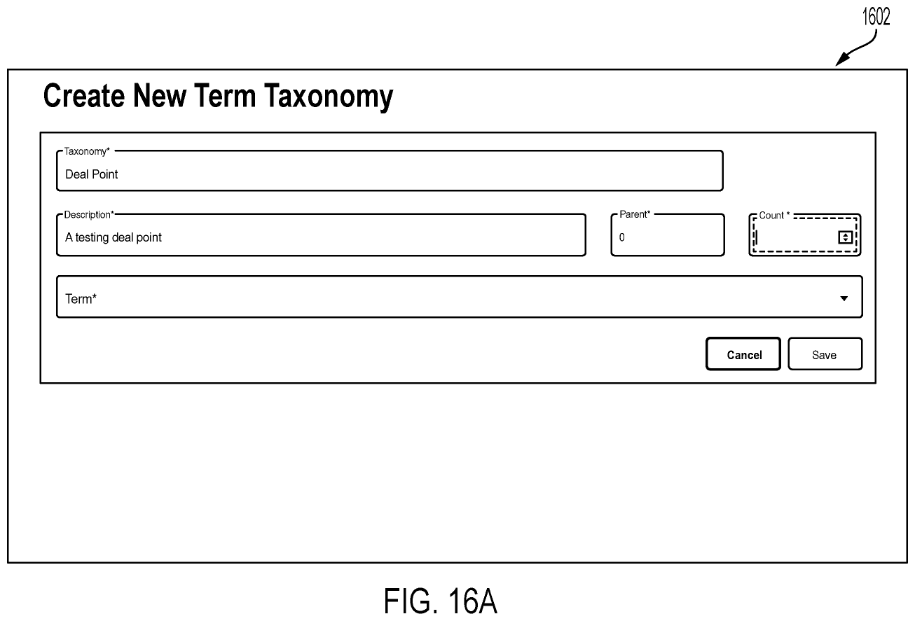

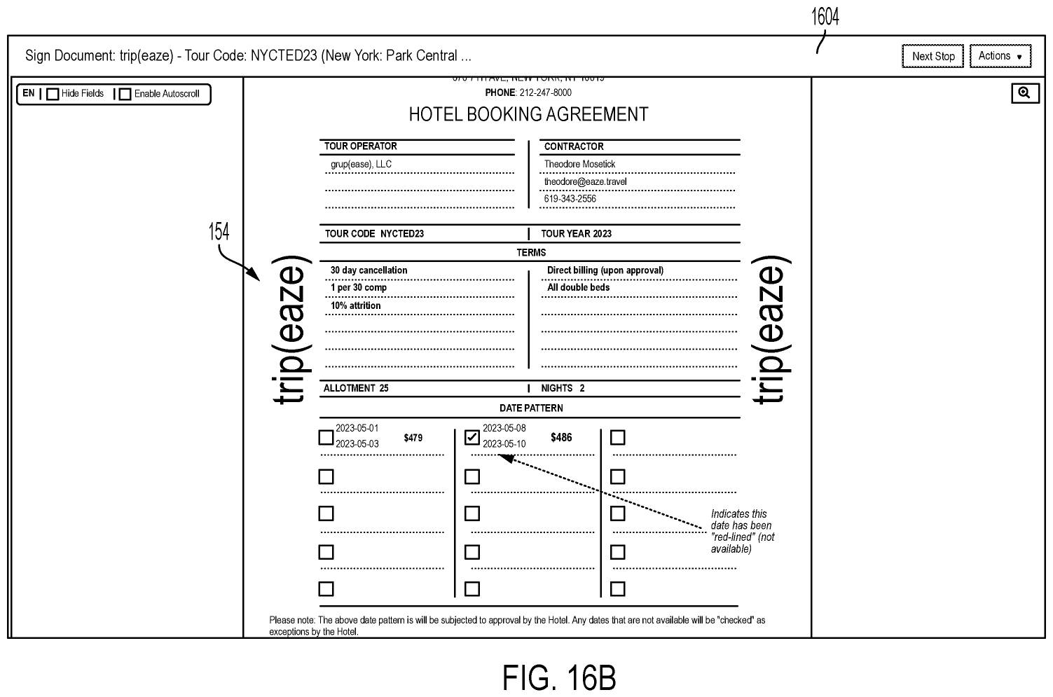

The example server 102 is also configured to enable travel resource providers to change contract term parameters 904 of existing contract templates 152 and/or add or remove contract term parameters 904. Such a configuration empowers travel resource providers to adjust contract terms as needed. The changes may be made periodically and/or may be made on a temporary basis. FIGS. 15, 16A, and 16B are diagrams of user interfaces 1502, 1602, and 1604 provided by the server 102 for the travel resource providers to create new contract term parameters or amend current contract term parameters for a contract template 152, according to an example embodiment of the present disclosure. The user interfaces 1502, 1602, and 1604 may be provided via the third-party server 120 or another computing device of the travel resource provider. For example, a travel resource provider may use a smartphone or tablet computer to access the user interfaces 1502, 1602, and 1604.

The user interface 1502 specifies current contract term parameters for a property that is owned by a travel resource provider. The user interface 1502 enables any of the contract term parameters to be edited. The user interface 1502 also enables the contract term parameters to be removed or new terms to be added. The user interface 1502 further enables a new contract template 152 to be created. Selection of the “Add Term” option causes the server 102 to display the user interface 1602. As shown in FIG. 16A, the user interface 1602 includes fields for a term name, a term description, and parameters of the term such as count or term *.

The user interfaces 1502 and 1602 enable travel resource providers to easily set key contract terms without a labor intensive process or generating an entirely new document. Rather, the contract term parameters 904 specified in the user interface 1502 are automatically written or otherwise populated into the contract template 1502, as shown in FIG. 9. In some embodiments, the user interfaces 1502 and 1602 enable travel resource providers to provide dynamic contract templates that have terms that best reflect current business conditions that can be changed day-to-day as conditions change.

FIG. 16B is a diagram of a contract 154 displayed within a user interface 1604 of a device of a tour resource provider. At this point, the tour operator has selected this hotel and signed the contract 154. The server 102 then transmitted the contract 154 via email, for example, to the hotel supplier to review the dates and terms. In this case, one of the date ranges are unable to be fulfilled by the hotel. The contract 154 includes a box for each date range. Selection of the box indicates that the dates have been “red-lined” or are otherwise not available. The server 102 receives the red-lined dates and processes the red-lined dates as an exception that needs further fulfillment. Such a configuration enables a tour resource provider to adjust dates based on current availability when the contract 154 is formed. After counter-signing the contract 154, the tour resource provider may, in some embodiments, manually or automatically process the reservations for the rooms.

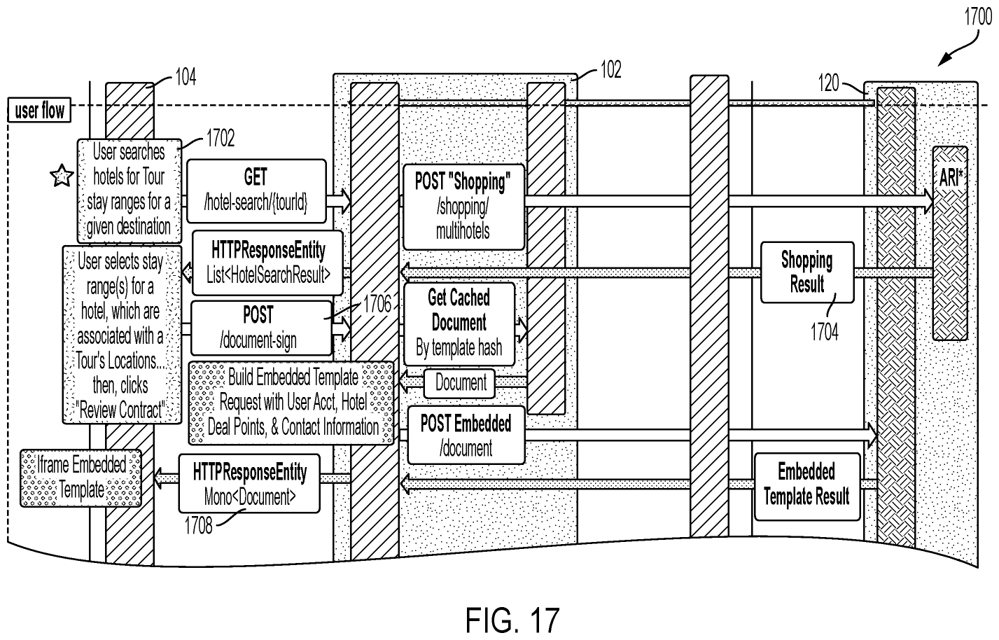

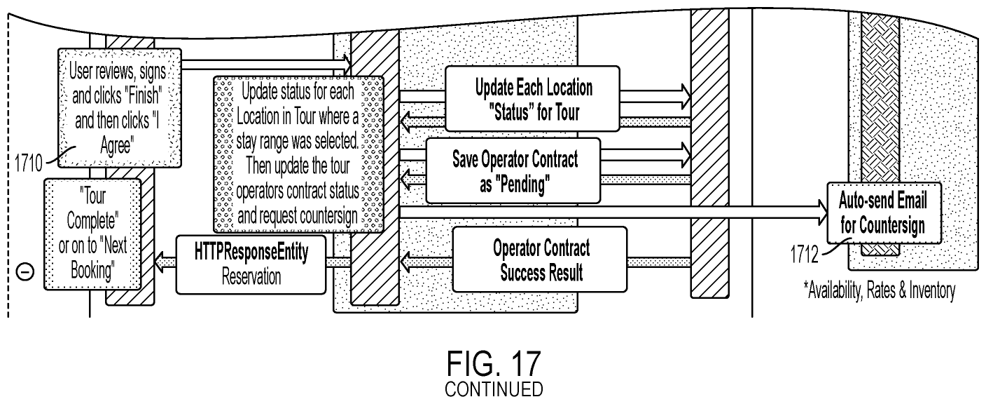

FIG. 17 is a diagram of another procedure 1700 for creating a contract 154, according to an example embodiment of the present disclosure. The procedure 1700 provides more granular data flow for the operations described in connection with the procedure 400 of FIGS. 4A and 4B. As shown in FIG. 17 at a first step 1702, a tour operator uses the application 112 on the device 104 to search for travel resources, such as hotels. The search criteria are used as search parameters and posted to one or more “shopping” APIs of the third-party servers 120. In reply at step 1704, the servers 120 transmit responses that list matching properties having at least one date range with availability. The server 102 converts the responses into a Hypertext Transfer Protocol (“HTTP”) response to display the search results 417 within the user interface 600 of the application 112 on the user device 104.

At step 1706 a user selects at least some date ranges for a property, which causes the server 102 to obtain a cached contract template 152. The server 102 then builds a complete contract 154 using the selected date ranges and corresponding prices for the selected property. In some embodiments, the server 102 posts the contract 154 to the server 120 and receives an embedded template result, which is passed to the device as an HTTP response at step 1708.

At step 1710, the tour operator reviews and signs the contract 154, which causes the server 102 to update the status of the date ranges specified in the contract. Further, the server 102 stores the contract 154 as pending. At step 1712 the server 102 transmits the contract 154 for counter-signing, which is then returned to the server 102 after the travel resource provider signs. The server 102 provides a HTTP response to the device 104 indicating that the contract 154 is finalized or otherwise complete. As discussed above, the above procedure 1700 can be carried out in a matter of minutes if not hours. This is significantly more efficient compared to known group travel contracting, which uses separate contracts for each provider and can take weeks or months until all travel resources are fully contracted.

### IV. CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1: A group travel resource contract generation system comprising:
an interface communicatively coupled to a network, the interface configured to receive an electronic travel resource planning document from a tour operator device, the electronic travel resource planning document including cities, arrival dates for the cities, departure dates for the cities, and a number of units needed for the arrival and departure dates;
a memory device storing (i) contract term parameters specified by travel resource providers for a respective travel resource, and (ii) a contract template for each travel resource provider specifying the contract term parameters for the respective travel resource; and
a processor communicatively coupled to the interface and the memory device, the processor configured to:
receive the electronic travel resource planning document, the electronic travel resource planning document including a plurality of cities, corresponding arrival dates and departure dates for each of the cities, and a number of units needed for the arrival and departure dates,
parse the electronic travel resource planning document by the cities,
determine a resource usage date range based on the arrival dates and the departure dates for each parsed city,
aggregate the resource usage date ranges for each parsed city,
select or receive a selection of one of the parsed cities,
transmit a request message to one or more servers of the travel resource providers specifying the resource usage date ranges for the selected parsed city and the corresponding number of units needed for the resource usage date ranges,
receive response message from the one or more servers, each response message being for a particular travel resource and specifying an availability or inventory indicator for the number of units needed and a resource rate for the resource usage date ranges,
determine travel resources that have availability or inventory for at least one of the resource usage date ranges based on the availability or inventory indicator,
for each of the travel resources with at least some availability or inventory, obtain travel resource information related to the travel resource including text and graphics,
for the travel resources with at least some availability or inventory, cause the obtained travel resource information to be displayed in a user interface of the tour operator device in conjunction with indicators of availability for each of the resource usage date ranges and the resource rate for each of the resource usage date ranges,
receive a selection of at least one resource usage date range for one of the displayed travel resources from the tour operator device via the network,
select the contract template that corresponds to the selected travel resource,
edit the contract template to create a complete contract file by adding the selected at least one resource usage date range, the number of units, and the corresponding resource rate,
cause the complete contract file to be displayed via the user interface of the tour operator device,
receive from the tour operator device via the network the compete contract file with an electronic signature, and
store the compete contract file with the electronic signature to the memory device and transmit the compete contract file with the electronic signature to the server of the selected travel resource for a counter-signature.

2: The system of claim 1, wherein the processor is further configured to:
display a list of available contract term parameters within the user interface;
receive a selection of one of the available contract term parameters;
filter the travel resources with at least some availability or inventory that include the selected contract term parameter within the corresponding contract template; and
cause the travel resource information for the filtered travel resources to be displayed in the user interface of the tour operator device in conjunction with indicators of availability for each of the resource usage date ranges and the resource rate for each of the resource usage date ranges.

3: The system of claim 1, wherein the processor is further configured to:
after receiving the selection of the at least one resource usage date range for one of the displayed travel resources, calculate a new resource rate for the selected at least one resource usage date range; and
display the new resource rate within the user interface in relation to the travel resource for the selected at least one resource usage date range.

4: The system of claim 1, wherein the processor is further configured to:
receive the compete contract with the counter-signature from the server of the selected travel resource;
store the compete contract with the counter-signature to the memory device; and
provide an indication that the at least one resource usage date range for the corresponding city is reserved.

5: The system of claim 1, wherein the processor is further configured to:
after the compete contract with the electronic signature is transmitted to the server of the selected travel resource, remove the at least one resource usage date range; and
for the travel resources with at least some availability or inventory, cause the obtained travel resource information to be displayed in a user interface of the tour operator device in conjunction with indicators of availability for each of the resource usage date ranges and the resource rate for each of the resource usage date ranges excluding the removed the at least one resource usage date range.

6: The system of claim 1, wherein the processor is further configured to order the travel resources for display within the user interface based on at least one of greatest amount of availability or inventory or an average resource rate for the resource usage date ranges with availability.

7: The system of claim 1, wherein the number of units needed is a number of rooms needed and the travel resource is a hotel or other lodging property.

8: The system of claim 1, wherein the travel resource information includes at least one of available amenities, a rating, a description, or one or more pictures related to the travel resource.

9: The system of claim 1, wherein the contract term parameters include at least one of a cancellation period, an attrition percentage, a comp policy, a billing policy, a bed type, a parking policy, and a porterage policy.

10: The system of claim 1, wherein the processor is further configured to:
after the compete contract with the electronic signature is transmitted to the server of the selected travel resource, select or receive a selection of another one of the parsed cities;
transmit a second request message to the one or more servers of the travel resource providers specifying the resource usage date ranges for the other selected parsed city and the corresponding number of units needed for the resource usage date ranges;
receive second response messages from the one or more servers, each second response message being for a particular travel resource and specifying an availability or inventory indicator for the number of units needed and a resource rate for the resource usage date range;
determine second travel resources that have availability or inventory for at least one of the resource usage date ranges based on the availability or inventory indicator;
for each of the second travel resources with at least some availability or inventory, obtain second travel resource information related to the second travel resource including text and graphics;
for the second travel resources with at least some availability or inventory, cause the obtained second travel resource information to be displayed in the user interface of the tour operator device in conjunction with indicators of availability for each of the resource usage date ranges and the resource rate for each of the resource usage date ranges;
receive a selection of at least one resource usage date range for one of the displayed second travel resource from the tour operator device via the network;
select the contract template that corresponds to the selected second travel resource;
edit the contract template to create a complete second contract file by adding the selected at least one resource usage date range and the corresponding resource rate;
cause the complete second contract file to be displayed via the user interface of the tour operator device;
receive from the tour operator device via the network the compete second contract file with an electronic signature; and
store the compete second contract file with the electronic signature to the memory device and transmit the compete second contract with file the electronic signature to the server of the selected second travel resource for a counter-signature.

11: The system of claim 1, wherein the processor is further configured to transmit a reservation message to the server of the selected travel resource to lock in the specified number of units for the selected at least one resource usage date range.

12: The system of claim 1, wherein the processor is further configured to transmit a separate request message to the one or more servers of the travel resource providers for each separate resource usage date range.

13: The system of claim 1, wherein the processor is further configured to:
start a timer when the compete contract file with the electronic signature is transmitted to the server of the selected travel resource for the counter-signature;
determine the compete contract file with the counter-signature has not been returned when the timer reaches a threshold; and
transmit a reminder message to the server of the selected travel resource.

14: The system of claim 13, wherein the threshold is a time duration between one hour and one week.

15: A group travel resource contract generation method comprising:
receiving, in an interface communicatively coupled to a network, an electronic travel resource planning document from a tour operator device, the electronic travel resource planning document including location names, arrival dates for each of the location names, departure dates for each of the location names, and a number of units needed for the arrival and departure dates;
parsing, via a processor communicatively coupled to the interface, the electronic travel resource planning document by the location names;
determining, via the processor, a resource usage date range based on the arrival dates and the departure dates for each parsed location name;
aggregating, via the processor, the resource usage date ranges for each parsed location name;
receiving, in the processor, a selection of one of the parsed location names;
transmitting, from the processor, a request message to one or more servers of the travel resource providers specifying the resource usage date ranges for the selected parsed location name and the corresponding number of units needed for the resource usage date ranges;
receiving, in the processor, a response message from the one or more servers, each response message being for a particular travel resource and specifying an availability or inventory indicator for the number of units needed and a resource rate for the resource usage date ranges;
determining, via the processor, travel resources that have availability or inventory for at least one of the resource usage date ranges based on the availability or inventory indicator;
for each of the travel resources with at least some availability or inventory, obtaining, via the processor, travel resource information related to the travel resource including text and graphics;
for the travel resources with at least some availability or inventory, causing, via the processor, the obtained travel resource information to be displayed in a user interface of the tour operator device in conjunction with indicators of availability for each of the resource usage date ranges and the resource rate for each of the resource usage date ranges;
receiving, in the processor, a selection of at least one resource usage date range for one of the displayed travel resources from the tour operator device via the network;
selecting, via the processor, a contract template that corresponds to the selected travel resource, the contract template specifying contract term parameters for the respective travel resource;
editing, via the processor, the contract template to create a complete contract file by adding the selected at least one resource usage date range, the number of units, and the corresponding resource rate;
causing, via the processor, the complete contract file to be displayed via the user interface of the tour operator device;
receiving in the processor from the tour operator device via the network, the compete contract file with an electronic signature; and
storing, via the processor, the compete contract file with the electronic signature to a memory device and transmit the compete contract file with the electronic signature to the server of the selected travel resource for a counter-signature.

16: The method of claim 15, further comprising:
causing, via the processor, a list of available contract term parameters to be displayed within the user interface;
receiving, in the processor, a selection of one of the available contract term parameters;
filtering, via the processor, the travel resources with at least some availability or inventory that include the selected contract term parameter within the corresponding contract template; and
causing, via the processor, the travel resource information for the filtered travel resources to be displayed in the user interface of the tour operator device in conjunction with indicators of availability for each of the resource usage date ranges and the resource rate for each of the resource usage date ranges.

17: The method of claim 15, further comprising:
after receiving the selection of the at least one resource usage date range for one of the displayed travel resources, calculating, via the processor, a new resource rate for the selected at least one resource usage date range; and
causing, via the processor, the new resource rate to be displayed within the user interface in relation to the travel resource for the selected at least one resource usage date range.

18: The method of claim 15, further comprising:
receiving, in the processor, the compete contract with the counter-signature from the server of the selected travel resource;
storing, via the processor, the compete contract with the counter-signature to the memory device; and
providing, via the processor, an indication that the at least one resource usage date range for the corresponding location name is reserved.

19: The method of claim 15, further comprising:
after the compete contract with the electronic signature is transmitted to the server of the selected travel resource, removing, via the processor, the at least one resource usage date range; and
for the travel resources with at least some availability or inventory, causing, via the processor, the obtained travel resource information to be displayed in a user interface of the tour operator device in conjunction with indicators of availability for each of the resource usage date ranges and the resource rate for each of the resource usage date ranges excluding the removed the at least one resource usage date range.

20: The method of claim 15, further comprising ordering, via the processor, the travel resources for display within the user interface based on at least one of greatest amount of availability or inventory or an average resource rate for the resource usage date ranges with availability.
